(19) United States
(12) Patent Application Publication
(10) Pub. No.: US 2007/0129278 A1
(43) Pub. Date: Jun. 7, 2007

(54) Floor treatment compositions

(75) Inventor: Delford Ian Christmas, Montvale, NJ (US)

Correspondence Address: NORRIS, MCLAUGHLIN & MARCUS, 875 THIRD AVE, 18TH FLOOR, NEW YORK, NY, 10022, US

(73) Assignee: RECKITT BENCKISER INC., Parsippany, NJ (US)

(21) Appl. No.: 10/595,966

(22) PCT Filed: Sep. 27, 2004
(86) PCT No.: PCT/GB04/04096

§ 371 Date: May 23, 2006

(30) Foreign Application Priority Data
Nov. 26, 2003 (GB) 0327414.9

(51) Int. Cl. C11D 17/08

(52) U.S. Cl. 510/421; 510/505; 510/490

(57) ABSTRACT

Hard surface cleaning composition which is particularly well adapted for the cleaning treatment of flooring surfaces, particularly finished wood flooring, finished wood veneer flooring and finished non-wood flooring surfaces including laminate flooring surfaces.

The present invention relates to hard surface treatment compositions. More particularly the present invention is related to hard surface cleaning compositions which are particularly useful in the treatment of flooring surfaces, especially wood flooring surfaces.

A wide variety of floor cleaning compositions, particularly floor cleaning compositions which are specifically formulated to address the particular technical requirements of different flooring materials, or to address the specific technical problems associated with the treatment and/or removal of particular classes of soils from particular flooring materials are known. Examples of such floor cleaning compositions include the following.

U.S. Pat. No. 4,230,605 is directed to a floor cleaning composition which is particularly directed to the maintenance of the high gloss level of “no-wax” products. The cleaning compositions consists essentially of an aqueous emulsion of a terpolymer having an average molecular weight of about 23,000, said terpolymer being an addition polymer based on about 51% by weight methyl methacrylate, 31% by weight butyl acrylate and 18% by weight of acrylic acid. Further essential constituents include a particular surfactant, (at a preferred ratio the terpolymer to the surfactant is 80:20 parts by weight,) a solvent such as ethylene glycolmonobutylether and ammonia which is necessary to solubilize the terpolymer. Water in a large proportion is the final essential constituent. Further optional conventional additives such as those known to the art may also be added.

U.S. Pat. No. 4,861,518 provides certain improved solid floor cleaning concentrate compositions which solid compositions are ultimately intended to be diluted and mixed by the consumer or other end user at the time of application to the flooring surface. The solid floor cleaner composition comprises generally 7-16% by weight of at least one surfactant, but preferably two different nonionic surfactants, 5-20% by weight of an organic solvent which is able to solubilize greasy stains such as monoethanolamine, ethyleneglycolmonobutylether, or diethyleneglycolmonoethylether; an alkali such as potassium hydroxide or sodium hydroxide so to maintain the pH of the solid cleaning concentrate composition at a pH of at least 9, but preferably, 11.5 to 12; and 15-50% by weight of a water soluble organic carrier which creates a solid matrix which is desirably a polyethylene glycol of 3,000-8,000 molecular weight. The cleaning composition concentrates taught therein are formed by first heating all of the constituents so to form a molten mixture therefrom, and subsequently casting said molten composition preferably into capsule containers.

U.S. Pat. No. 5,266,088 is directed to a water-based polish composition. Said polish composition is recited being particularly useful for the polishing of non-porous surfaces. The composition comprises 1-3% of a thickener such as an industrial gum or synthetic polymer, 5-13% by weight of at least one particulate abrasive material, and optionally, but preferably, at least one surfactant selected from a broad class of anionic, cationic, nonionic and amphoteric surfactants, and the balance, water. The composition provides a shelf stable dispersion of the particulate abrasive in the water-based composition wherein the abrasive material is readily redispersed by manual shaking of the container when the cleaning composition is in a liquid form. The compositions are particularly useful for the cleaning of non-porous surfaces including a wide variety of glass, metal, plastic, ceramic, semi-conducting materials, metallurgical and geological specimens, painted surfaces, waxed surfaces, glass, plastic, anodized aluminum surfaces, and are particularly cited as being very useful in the polishing of wax floors and marble floors. The presence of the finely divided particulates in the compositions are taught to be useful in the removal of surface scratches on said hard surfaces.

U.S. Pat. No. 5,700,768 is directed to floor cleaning compositions featuring low residue/film formation, methods for their production and processes for their use are disclosed. The compositions are aqueous floor cleaning compositions comprising a non-ionic surfactant having an average molecular weight of about 2,000 and greater, a clarifying effective amount of an amphoteric solubilizer, and an anionic low foaming surfactant. Further optional constituents may also be included.

While these prior art compositions may be effective in addressing individual needs of particular flooring compositions, not all of these are specifically advantageously used for the cleaning treatment of as finished wood flooring, finished wood veneer flooring and finished non-wood flooring surfaces which are intended to provide the appearance of wood flooring surfaces, which are often referred to as wood laminate flooring which may or may not include an uppermost layer which is formed from or using wood. Such flooring compositions commonly include an uppermost coat or “topcoat” of polyurethane, varnish finish or other finish composition which is intended on the one hand to seal the substrate underneath especially wood or wood veneer surfaces from undue moisture and to provide a durable barrier to spills of foreign substances onto the flooring surface while at the same time to retain an attractive appearance particularly over days, weeks, months and years of normal use. This is particularly true of so called prefinished flooring products which are supplied from their manufacturer with an optional stain, and with a topcoat of polyurethane, varnish finish or other finish composition which substantially reduces installation time of a flooring surface as the traditional post-installation surface sanding and subsequent surface finishing operation may be eliminated. Such an operation is both time and labor intensive. Understandably finished wood flooring, finished wood veneer flooring and finished non-wood flooring surfaces which are intended to provide the appearance of wood flooring surfaces have become increasingly popular.

While the prior art patents discuss various useful compositions which are useful in the treatment of various flooring surfaces, there nonetheless remains a real and continuing need in the art for improved floor treatment compositions. Particularly there remains a real and continuing need in the art for providing effective cleaning compositions particularly suited for the cleaning treatment of finished wood flooring, finished wood veneer flooring and finished non-wood flooring surfaces which are intended to provide the appearance of wood flooring surfaces which on the one hand provides effective cleaning of stains, spills and other unwanted deposits, while on the other hand repeated use of the cleaning composition does not deleteriously affect the topcoat composition, especially aqueous based or oil based polyurethane compositions. Ideally such a cleaning composition would also be useful in providing a gloss or shine to such flooring surfaces.

These and other objects of the invention will become more apparent from a reading of the following specification.

According to a first aspect, the present invention provides a hard surface cleaning composition which is particularly well adapted for the cleaning treatment of flooring surfaces, which composition comprises (but preferably consists of, more preferably consists essentially of):

a nonionic surfactant based on ethoxy/propoxy block copolymers having a molecular weight of at least about 2200;

an amphoteric hydrotrope;

optionally but particularly desirably, one or more further detersive surfactants, preferably one or more anionic surfactants but preferably at least one anionic surfactant is present in conjunction with the nonionic surfactant constituent;

optionally one or more conventional additives; and,

water.

Optional further constituents include further solubilizing agents/compatabilizing agents, fragrances, coloring agents, pH adjusting agents, buffers, preservatives, chelating agents, germicides, antifoaming agents, further surfactants including anionic, cationic, non-ionic, and amphoteric surfactants, as well as other conventional additives known to the art relating to such floor cleaning compositions. The preferred optional constituents generally are present in only minor amounts, generally comprising a total of less than 20% by weight of the total weight of a composition.

Preferred embodiments of the inventive compositions provide excellent cleaning of hard surfaces particularly flooring surfaces such as finished wood flooring, finished wood veneer flooring and finished non-wood flooring surfaces which are intended to provide the appearance of wood flooring surfaces, which are often referred to as wood laminate flooring which may or may not include an uppermost layer which is formed from or using wood, as well as imparting an gloss or shine finish to the treated flooring surfaces.

According to a second aspect of the invention there is provided an improved process for the cleaning treatment of a hard surface, preferably a finished wood flooring, finished wood veneer flooring and finished non-wood flooring surfaces which are intended to provide the appearance of wood flooring surfaces which process comprises the step of:

providing a quantity of a composition according to the first aspect of the invention in a cleaning effective amount to a hard surface.

According to a preferred embodiment of the invention the compositions exclude traditional organic solvents, particularly alcohols, glycols, glycol ethers and glycol ether acetates which are often used to penetrate surface soils.

The inventive compositions necessarily include one or more nonionic surfactants based on ethoxy/propoxy block copolymers having a molecular weight of at least about 2200, preferably a molecular weight of at least about 2500. Polymeric alkylene oxide block copolymers include nonionic surfactants in which, preferably a major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):
HO-(EO)ₓ(PO)_{y}(EO)—H (A)
where
EO represents ethylene oxide,
PO represents propylene oxide,
y equals at least 15,
(EO)_{x+y} equals 20 to 50% of the total weight of said compounds, and, the total molecular weight is preferably in the range of about 2500 to 15,000. These surfactants are available under the PLURONIC (ex. BASF) or Emulgen (ex. Kao.)

A further group of such useful nonionic surfactants containing the characteristic alkylene oxide blocks are those can be represented by the formula (B):
R-(EO,PO)ₐ(EO,PO)_{b}—H (B)
wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block. Specific nonionic surfactants which in general are encompassed by Formula B include butoxy derivatives of propylene oxide/ethylene oxide block polymers having molecular weights within the range of about 2500-5000.

Still further examples of useful nonionic surfactants include those which can be represented by formula (C) as follows:
RO—(BO)ₙ(EO)ₓ—H (C)
wherein
EO represents ethylene oxide,
BO represents butylene oxide,
R is an alkyl group containing 1 to 20 carbon atoms,
n is about 5-15 and x is about 5-15.

Yet further useful nonionic surfactants include those which may be represented by the following formula (D):
HO-(EO)ₓ(BO)ₙ(EO)_{y}—H (D)
wherein
EO represents ethylene oxide,
BO represents butylene oxide,
n is about 5-15, preferably about 15,
x is about 5-15, preferably about 15, and
y is about 5-15, preferably about 15.

Still further exemplary useful nonionic block copolymer surfactants include ethoxylated derivatives of propoxylated ethylene diamine, which may be represented by the following formula: 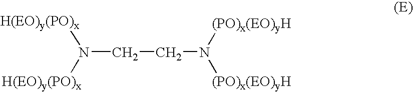
where
(EO) represents ethoxy,
(PO) represents propoxy,
   the amount of (PO)ₓ is such as to provide a molecular weight prior to ethoxylation of about 300 to 7500, and the amount of (EO)_{y} is such as to provide about 20% to 90% of the total weight of said compound.

As noted ethoxy/propoxy block copolymers having a molecular weight of at least about 2200, preferably at least about 2500. Desirably the required ethoxy/propoxy block copolymers do not exhibit a molecular weight in excess of 10,000 and preferably exhibit a molecular weight not in excess of about 8,000 and most preferably not in excess of about 6500.

Particularly satisfactory nonionic surfactants based on ethoxy/propoxy block copolymers having a molecular weight of at least about 2500 include those marketed as Pluronics® L62 and Pluronics® L64. ex. BASF.

In accordance with the present invention the one or more nonionic surfactants based on ethoxy/propoxy block copolymers is preferably present in amount of from about 0.001% by weight to about 10%, more preferably in an amount of about 7% by weight and less, still more preferably in amounts to about 5% by weight and less and most preferably in amounts to about 3% by weight and less, based on the total weight of the inventive composition.

The inventive compositions also necessarily include an amphoteric hydrotrope which is effective in improving the solubility of the aforesaid nonionic surfactants based on ethoxy/propoxy block copolymers in water. This constituent is desirably included in an amount effective in clarifying the inventive composition, particularly to be effective as a solubility enhancer at room temperature, viz., approximately 20° C., as well as elevated temperatures, viz., approximately 40° C.

The amphoteric hydrotropes useful in the use of the compositions of the present invention include known art hydrotrope compositions. Suitable hydrotropes include salts of aryl sulfonic acids such as naphtyl and benzene sulfonic acids, wherein the aromatic nucleus may be unsubstituted or substituted with lower alkyl groups, such as C.sub.1-4 alkyl groups, especially methyl, ethyl and/or isopropyl groups. Up to three of such substituents may be present in the aromatic nucleus, but preferably zero to two are preferred The salt forming cation of the hydrotrope is preferably an alkali metal such as sodium or potassium, especially sodium. However, other water soluble cations such as ammonium, mono-, di- and tri-lower alkyl, i.e., C₁-C₄ alkanol ammonium groups can be used in the place of the alkali metal cations. Exemplary hydrotropes include benzene sulfonates, o-toluene sulfonates, m-toluene sulfonates, and p-toluene sulfonates; 2,3-xylene sulfonates, 2,4-xylene sulfonates, and 4,6-xylene sulfonates; cumene sulfonates, wherein such exemplary hydrotropes are generally in a salt form thereof. Further exemplary hydrotropes include lower alkyl sulfate salts, particularly those having from about one to six carbon atoms in the alkyl group. Certain of these hydrotropes are also known as surfactants.

Preferred amphoteric hydrotropes include alkylampho(mono)propionates including those according to the general structure: 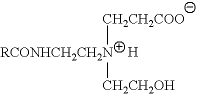
as well as alkylampho(di)propionates including those according to the general structure:

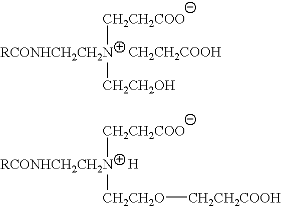

In each of the above indicated structures, R represents a C₈-C₂₄ alkyl group and desirably is a C₁₀-C₁₆ alkyl group, especially derived from soy or coconut the latter of which typically provides a mixture of C₈₋₁₀, C₁₂, C₁₄ and C₁₆ alkyl groups. Salt forms, e.g., sodium, of these compounds are particularly useful.

In certain particularly preferred embodiments of the invention, the amphoteric hydrotrope is Amphoterge® K-2, (Lonza Inc., Fair Lawn, N.J.) which is described to be disodium cocoamphodipropionate.

While the amphoteric hydrotrope may be present in any amount which is effective in improving the clarity of the inventive compositions, desirably it is present in amount of from about 0.001% by weight to about 10%, more preferably it is present in amounts of about 5% by weight and less, still more preferably in amounts of about 2% by weight based on the total weight of the liquid floor cleaning composition.

The inventor has found that in certain preferred compositions the total amount of the amphoteric hydrotrope present is present in an amount not in excess of 75% wt. of the total weight of the aforesaid nonionic surfactants based on ethoxy/propoxy block copolymers, more desirably the total amount of the amphoteric hydrotrope present is in an amount not in excess of 60% wt., most preferably is not in excess of 50% wt. of the nonionic surfactants based on ethoxy/propoxy block copolymers present in the compositions.

The inventive compositions optionally but particularly desirably also necessarily comprise one or more detersive surfactants, preferably one or more anionic surfactants or one or more nonionic surfactants or both. According to certain preferred embodiments at least one anionic surfactant is present, and more desirably both at least one anionic surfactant and at least one further nonionic surfactant are necessarily present in the inventive compositions.

Exemplary useful anionic surfactants such as alkali metal salts, ammonium salts, amine salts, aminoalcohol salts or the magnesium salts of one or more of the following compounds: alkyl sulfates, alkyl ether sulfates, alkylamidoether sulfates, alkylaryl polyether sulfates, alkylaryl sulfates, alkylaryl sulfonates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms. Of these anionic surfactants, the alkylaryl sulfonates are preferred, of which sodium dodecylbenzene sulfonate is particularly preferred. Such preferred alkylaryl sulfonates may be supplied as a constituent, or may be formed in situ by the reaction of appropriate molar amounts of sulfonic acid with a sodium comprising base material such as NaOH.

Anionic soap surfactants may also be present in the inventive compositions. Exemplary useful anionic soap surfactants include includes ordinary alkali metal soaps such as the sodium, potassium, ammonium and alkanol-ammonium salts of higher fatty acids containing from about 8 to about 24 carbon atoms and preferably from about 10 to about 20 carbon atoms. Suitable fatty acids can be obtained from natural sources such as, for instance, plant or animal esters (e.g., palm oil, coconut oil, babassu oil, soybean oil, castor oil, tallow, whale and fish oils, grease, lard, and mixtures thereof). The fatty acids also can be synthetically prepared (e.g., by the oxidation of petroleum, or by the Fischer-Tropsch process). Resin acids are suitable such as rosin and those resin acids in tall oil. Naphthenic acids are also suitable. Sodium and potassium soaps can be made by direct saponification of the fats and oils or by the neutralization of the free fatty acids which are prepared in a separate manufacturing process. Particularly useful is the sodium or potassium salt of the mixtures of fatty acids derived from castor oil, i.e., sodium or potassium castor oil soap. Of the anionic soap surfactants contemplated herein, the alkyl metal soaps, such as sodium soaps of naturally derived fatty acids, are preferred.

The inventive compositions may include at least one further nonionic surfactant as part of the detersive surfactant constituent. As nonionic surfactants, practically any hydrophobic compound having a carboxy, hydroxy, amido, or amino group with a free hydrogen attached to the nitrogen can be condensed with an alkylene oxide, especially ethylene oxide or with the polyhydration product thereof, a polyalkylene glycol, especially polyethylene glycol, to form a water soluble or water dispersible nonionic surfactant compound. By way of non-limiting example, particularly examples of suitable nonionic surfactants which may be used in the present invention include the following:

One class of useful nonionic surfactants include polyalkylene oxide condensates of alkyl phenols. These compounds include the condensation products of alkyl phenols having an alkyl group containing from about 6 to 12 carbon atoms in either a straight chain or branched chain configuration with an alkylene oxide, especially an ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

A further class, and a preferred class, of useful nonionic surfactants include the condensation products of aliphatic alcohols with from about 1 to about 60 moles of an alkylene oxide, especially an ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). Other examples are those C₆-C₁₁ straight-chain alcohols which are ethoxylated with from about 3 to about 6 moles of ethylene oxide. Their derivation is well known in the art. Examples include Alfonic® 810-4.5, which is described in product literature from Sasol as a C₈-C₁₀ straight-chain alcohol having an average molecular weight of 356, an ethylene oxide content of about 4.85 moles (about 60 wt. %), and an HLB of about 12; Alfonic® 810-2, which is described in product literature as a C₈-C₁₀ straight-chain alcohols having an average molecular weight of 242, an ethylene oxide content of about 2.1 moles (about 40 wt. %), and an HLB of about 12; and Alfonic® 610-3.5, which is described in product literature as having an average molecular weight of 276, an ethylene oxide content of about 3.1 moles (about 50 wt. %), and an HLB of 10. Other examples of alcohol ethoxylates are C₁₀ oxo-alcohol ethoxylates available from BASF under the Lutensol® ON tradename. They are available in grades containing from about 3 to about 11 moles of ethylene oxide (available under the names Lutensol® ON 30; Lutensol® ON 50; Lutensol® ON 60; Lutensol® ON 65; Lutensol® ON 66; Lutensol® ON 70; Lutensol® ON 80; and Lutensol®ON 110). Other examples of ethoxylated alcohols include the Neodol® 91 series non-ionic surfactants available from Shell Chemical Company which are described as C₉-C₁₁ ethoxylated alcohols. The Neodol® 91 series non-ionic surfactants of interest include Neodol® 91-2.5, Neodol® 91-6, and Neodol® 91-8. Neodol® 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule. Further examples of ethoxylated alcohols include the Rhodasurf® DA series non-ionic surfactants available from Rhodia which are described to be branched isodecyl alcohol ethoxylates. Rhodasurf® DA-530 has been described as having 4 moles of ethoxylation and an HLB of 10.5; Rhodasurf® DA-630 has been described as having 6 moles of ethoxylation with an HLB of 12.5; and Rhodasurf® DA-639 is a 90% solution of DA-630. Further examples of ethoxylated alcohols include those from Tomah Products (Milton, Wis.) under the Tomadol® tradename with the formula RO(CH₂CH₂O)ₙH where R is the primary linear alcohol and n is the total number of moles of ethylene oxide. The ethoxylated alcohol series from Tomah include 91-2.5; 91-6; 91-8—where R is linear C₉/C₁₀/C₁₁ and n is 2.5, 6, or 8; 1-3; 1-5; 1-7; 1-73B; 1-9; where R is linear C₁₁ and n is 3, 5, 7 or 9; 23-1; 23-3; 23-5; 23-6.5—where R is linear C₁₂/C₁₃ and n is 1, 3, 5, or 6.5; 25-3; 25-7; 25-9; 25-12—where R is linear C₁₂/C₁₃/C₁₄/C₁₅ and n is 3, 7, 9, or 12; and 45-7; 45-13—where R is linear C₁₄/C₁₅ and n is 7 or 13.

A further class of useful nonionic surfactants include primary and secondary linear and branched alcohol ethoxylates, such as those based on C₆-C₁₈ alcohols which further include an average of from 2 to 80 moles of ethoxylation per mol of alcohol. These examples include the Genapol® UD (ex. Clariant, Muttenz, Switzerland) described under the tradenames Genapol® UD 030, C₁₁-oxo-alcohol polyglycol ether with 3 EO; Genapol® UD, 050 C₁₁-oxo-alcohol polyglycol ether with 5 EO; Genapol® UD 070, C₁₁-oxo-alcohol polyglycol ether with 7 EO; Genapol® UD 080, C₁₁-oxo-alcohol polyglycol ether with 8 EO; Genapol® UD 088, C₁₁-oxo-alcohol polyglycol ether with 8 EO; and Genapol® UD 110, C₁₁-oxo-alcohol polyglycol ether with 11 EO.

Still further exemplary useful nonionic surfactants include the condensation products of a secondary aliphatic alcohols containing 8 to 18 carbon atoms in a straight or branched chain configuration condensed with 5 to 30 moles of ethylene oxide. Examples of commercially available nonionic detergents of the foregoing type are those presently commercially available under the trade name of Tergitol® such as Tergitol 15-S-12 which is described as being C₁₁-C₁₅ secondary alkanol condensed with 9 ethylene oxide units, or Tergitol 15-S-9 which is described as being C₁₁-C₁₅ secondary alkanol condensed with 12 ethylene oxide units per molecule.

A yet further class of useful nonionic surfactants include those surfactants having a formula:
RO(CH₂CH₂O)ₙH
wherein;
R is a mixture of linear, even carbon-number hydrocarbon chains ranging from C₁₂H₂₅ to C₁₆H₃₃ and n represents the number of ethoxy repeating units and is a number of from about 1 to about 12.

Surfactants of this formula are presently marketed under the Genapol® tradename (ex. Clariant), which surfactants include the “26-L” series of the general formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1, 26-L-1.6, 26-L-2,26-L-3,26-L-5, 26-L-45, 26-L-50, 26-L-60, 26-L-60N, 26-L-75, 26-L-80, 26-L-98N, and the 24-L series, derived from synthetic sources and typically contain about 55% C₁₂ and 45% C₁₋₄ alcohols, such as 24-L-3,24-L-45, 24-L-50, 24-L-60, 24-L-60N, 24-L-75, 24-L-92, and 24-L-98N, all sold under the Genapol® tradename.

Further nonionic surfactants which may be included in the inventive compositions include alkoxylated alkanolamides, preferably C₈-C₂₄ alkyl di(C₂-C₃ alkanol amides), as represented by the following formula:
R₅—CO—NH—R₆—OH
wherein R₅ is a branched or straight chain C₈-C₂₄ alkyl radical, preferably a C₁₀-C₁₆ alkyl radical and more preferably a C₁₂-C₁₄ alkyl radical, and R₆ is a C₁-C₄ alkyl radical, preferably an ethyl radical.

According to certain particularly preferred embodiments the detersive surfactant constituent necessarily comprises a nonionic surfactant based on a linear primary alcohol ethoxylate particularly wherein the alkyl portion is a C₈ to C₁₆, but particularly a C₉ to C₁₁ alkyl group, and having an average of between about 6 to about 8 moles of ethoxylation.

Still further suitable nonionic surfactants include the polyethylene oxide condensates of one mole of alkyl phenol containing from about 8 to 18 carbon atoms in a straight- or branched chain alkyl group with about 5 to 30 moles of ethylene oxide. Specific examples of alkyl phenol ethoxylates include nonyl condensed with about 9.5 moles of EO per mole of nonyl phenol, dinonyl phenol condensed with about 12 moles of EO per mole of phenol, dinonyl phenol condensed with about 15 moles of EO per mole of phenol and diisoctylphenol condensed with about 15 moles of EO per mole of phenol. Commercially available nonionic surfactants of this type include Igepal CO-630 (nonyl phenol ethoxylate) marketed by ISP Corporation.

Particularly preferred anionic surfactants and particularly preferred nonionic surfactants are disclosed in one or more of the accompanying Examples.

While only optionally included in the inventive compositions desirably at least one anionic surfactant, or at least one further nonionic surfactant is desirably present in the inventive compositions. Optionally but most desirably both an anionic surfactant and a further nonionic surfactant are necessarily present in the inventive compositions. When present, the one or more further detersive surfactants may be present in any amount which is effective in improving the cleaning properties of the inventive compositions, desirably it is present in amount of from about 0.001% by weight to about 10%, more preferably the total amounts of the further detersive surfactants are present in amounts of to about 5% by weight and less, still more preferably in amounts to about 3% by weight based on the total weight of the composition of which they form a part.

The inventive compositions may include one or more further optional constituents including but not limited to: solubilizing agents/compatabilizing agents, fragrances, coloring agents, pH adjusting agents, buffers, preservatives, chelating agents, germicides, antifoaming agents, further surfactants including anionic, cationic, non-ionic, and amphoteric surfactants, as well as other conventional additives known to the art relating to such floor cleaning compositions.

Optional, but desirable constituents include fragrances, natural or synthetically produced. Such fragrances may be added in any conventional manner, admixing to a concentrate composition or blending with other constituents used to form a concentrate composition, in amounts which are found to be useful to enhance or impart the desired scent characteristic to the concentrate composition, and/or to cleaning compositions formed therefrom. In compositions which include a fragrance, it is frequently desirable to include a fragrance solubilizer which assists in the dispersion, solution or mixing of the fragrance constituent in an aqueous base. This is very practical in low solid content formulations such as that taught herein, so to aid in the solubilization of oil based fragrances into an aqueous system. These include known art compounds, including condensates of 2 to 30 moles of ethylene oxide with sorbitan mono- and tri-C₁₀-C₂₀ alkanoic acid esters having a HLB of 8 to are also known as nonionic surfactants. Further examples of such suitable surfactants include water soluble nonionic surfactants of which many are commercially known and by way of non-limiting example include the alcohol ethoxylates, alkylphenol ethoxylates and ethylene-oxide-propylene oxide condensates on primary alkanols, and condensates of ethylene oxide with sorbitan fatty acid esters. This fragrance solubilizer component is added in minor amounts, particularly amount which are found effective in aiding in the solubilization of the fragrance component, but not in any significantly greater proportion, such that it would be considered as a detergent constituent. Such minor amounts recited herein are dependent on the amount of fragrance used generally up to about 0.25% by weight of the total composition but is more generally an amount of about 0.1% by weight and less, and preferably is present in amounts of about 0.05% by weight and less.

Further optional, but advantageously included constituents are one or more coloring agents which find use in modifying the appearance of the concentrate compositions and enhance their appearance from the perspective of a consumer or other end user. Known coloring agents, may be incorporated in the compositions in any effective amount to improve or impart to concentrate compositions a desired appearance or color. Such a coloring agent or coloring agents may be added in a conventional fashion, i.e., admixing to a concentrate composition or blending with other constituents used to form a concentrate composition.

The compositions optionally but desirably include an effective amount of a pH adjusting constituent, so to establish and/or maintain the composition at a desired pH. Such pH adjusting constituents may be compounds or compositions such as acids or bases used to adjust the pH of a composition or may be compounds or compositions used to buffer the pH of a composition and maintain it within acceptable limits. The use of one or more pH adjusting constituents, including agents known to the art such a minor amounts of mineral acids, basic compositions, and organic acids may be used. While the composition of the invention generally does not require a pH adjusting constituent, the use of such a pH buffering constituent may provide extra stability of a preservative constituent as well as for the whole system which concomitantly enhances the composition's shelf life.

Any pH buffering compound or pH buffer composition which is compatible with the aqueous compositions taught herein may be used as the pH adjusting constituent, and many of these are well known to the art. Examples of such useful pH buffer compounds and/or pH buffering systems or compositions the alkali metal phosphates, polyphosphates, pyrophosphates, triphosphates, tetraphosphates, silicates, metasilicates, polysilicates, carbonates, hydroxides, and mixtures of the same. Certain salts, such as the alkaline earth phosphates, carbonates, hydroxides, can also function as buffers. It may also be suitable to use buffers such materials as aluminosilicates (zeolites), borates, aluminates and certain organic materials such as gluconates, succinates, maleates, and their alkali metal salts.

Exemplary pH adjusting constituents include alkali metal salts of various inorganic acids, such as alkali metal phosphates, polyphosphates, pyrophosphates, triphosphates, tetraphosphates, silicates, metasilicates, polysilicates, borates, carbonates, bicarbonates, hydroxides, and mixtures of same. A preferred pH adjusting constituent is an alkali metal hydroxide, especially sodium hydroxide. Also suitable as pH adjusting agents are monoethanolamine compounds, such as diethanolamine and triethanolamine, and beta-aminoalkanol compounds, particularly beta-aminoalkanols having a primary hydroxyl group, and a mixture thereof. Further useful pH adjusting constituents include minor amounts of acids, including inorganic acids such as sulfuric acid or hydrochloric acid, as well as organic acids such as C₁-C₆ organic compounds containing a carboxylic acid moiety (—COOH) such as citric acid which is widely available, effective and a preferred pH adjusting constituent.

Typically such pH adjusting constituents, when present, are necessary in only minor amounts, e.g, from about 0.001% wt. to about 1% wt., more preferably in an amount not in excess of 0.8% wt, most preferably in an amount not in excess of 0.5% wt. While the composition of the invention generally does not require a pH adjusting constituent, the use of such a pH adjusting constituent may provide the benefit of stability of a preservative constituent which often requires certain pH range to be active and stable.

The inventive compositions desirably exhibit a pH in the range of 3-10, preferably from about 4-8, most preferably about 6-7. If necessary one or more pH adjusting agents, e.g., pH buffers or other pH adjusting compositions may be included in order to provide or establish a desired pH for the inventive composition.

The inventive compositions optionally but desirably comprise a preservative constituent. Since a significant portion of the inventive compositions comprise water, it is preferably that the preservative be water soluble. Desirably, the selected water soluble preservatives are those which exhibit stability and efficacy in the aqueous compositions according to the invention at neutral, but preferably at acidic pH's especially in the preferred pH ranges of the inventive compositions. Such water soluble preservatives include compositions which include parabens, including methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof. One exemplary composition is a combination 5-chloro-2-methyl-4-isothiazolin-3-one and 2-methyl-4-isothiazolin-3-one where the amount of either component may be present in the mixture anywhere from 0.001 to 99.99 weight percent, based on the total amount of the preservative. For reasons of availability, the most preferred preservative are those commercially available preservative comprising a mixture of 5-chloro-2-methyl-4-isothiazolin-3-one and 2-methyl-4-isothiazolin-3-one marketed under the trademark KATHON® CG/ICP as a preservative composition presently commercially available from Rohm and Haas (Philadelphia, Pa.). Further useful preservative compositions include KATHON® CG/ICP II, a further preservative composition presently commercially available from Rohm and Haas (Philadelphia, Pa.), PROXEL® which is presently commercially available from Zeneca Biocides (Wilmington, Del.), SUTTOCIDE® A which is presently commercially available from Sutton Laboratories (Chatam, N.J.) as well as TEXTAMER® 38AD which is presently commercially available from Calgon Corp. (Pittsburgh, Pa.). Particularly preferred for use in the inventive composition is a preparation containing 1,3-dihydroxymethyl-5,5-dimethylhydantion and 3-iodo-2-propynyl butyl carbamate which is presently commercially available as Dantogard® Plus Liquid from Lonza Corp. (Fairlawn, N.J.)

When included, the preservative constituent is present in the dilutable hard surface cleaning compositions of the present invention in any amount which is effective in retarding or eliminating the growth of undesired microorganisms in the inventive compositions particularly upon standing. When included, the preservative constituent need be present in only minor amounts, and is advantageously present in amounts for from about 0.001% wt. to about 0.5% wt., more preferably is present in an amount of from about 0.01-0.2 wt. In preferred embodiments of the invention the preservative constituent is necessarily present.

The inventive compositions optionally but in some cases desirably comprise a defoaming constituent. Such a constituent is used to suppress the formation of foam of one or more of the surfactants constituents present in the inventive compositions. Examples of defoaming constituent suitable for use in the present compositions include silicone compounds such as silica dispersed in polydimethylsiloxane, fatty amides, hydrocarbon waxes, fatty acids, fatty esters, fatty alcohols, fatty acid soaps, ethoxylates, mineral oils, polyethylene glycol esters, alkyl phosphate esters such as monostearyl phosphate, and the like. When included, the defoaming constituent need be present in only minor amounts, and is advantageously present in amounts for from about 0.001% wt. to about 0.5% wt., more preferably is present in an amount of from about 0.01-0.2% wt.

Such optional, i.e., non-essential constituents including those recited above are generally are present in only minor amounts, generally comprising a total of less than 20% by weight of the total weight of a composition, more preferably less than 10% wt, and most preferably less than 5% wt. of the inventive composition of which they form a part. Preferably, as has been noted the compositions do not include an organic solvent as a soil releasing agent. Organic solvents are desirably excluded as the present inventors have found that the contact of one or more organic solvents, especially prolonged contact, is often deleterious to the floor finish, particularly to flooring surfaces coated or treated with a finishing composition based on one or more organic polymers, including polyurethanes, varnishes, shellacs, as well as more recently available aqueous polymer dispersions such as that marketed as Polycrylics® (Minwax Co., Montville N.J.), and the like. They are however substantially absent if present in very minor amounts (<0.01% wt.) when they are used as solubilizing agents for certain fragrances which may be optionally, but desirably, included in the present inventive compositions. Desirably however such organic solvents are absent from the inventive compositions.

Water forms the predominant constituent of the inventive compositions and is added in order to provide 100 wt % of the concentrate composition. The water may be tap water, but is preferably distilled and/or deionized water. If the water is tap water, it is preferably appropriately filtered in order to remove any undesirable impurities such as organics or inorganics, especially mineral salts which are present in hard water which may thus interfere with the operation of the other constituents of the invention, as well as any other optional components of the liquid concentrates according to the invention. In preferred embodiments the inventive compositions comprise at least 92% wt. water, more preferably at least 94% wt. water. Particularly preferred embodiments, and the amount of water present are recited in the Examples.

The inventor has surprisingly found that by the careful selection of the constituents described above, excellent floor cleaning compositions may be produced which provide good cleaning without deleterious effects of the cleaned flooring surface. Nothwithstanding the substantial or complete of organic solvents in such very minor amounts, but preferably in the absence of organic solvents, the inventor has surprisingly found that the inventive compositions exhibit excellent cleaning of flooring surfaces. This is further surprising as in preferred embodiments the inventive compositions comprise at least 92% wt. water, more preferably at least 94% wt. water. Surprisingly such excellent cleaning has been observed even at the relative vol %/vol % dilution of concentrate:water of 1:16.

According to a particularly preferred embodiment, the present invention provides a hard surface cleaning composition at a pH of not more than 7 which is particularly well adapted for the cleaning treatment of flooring surfaces, which composition comprises (but preferably consists of, more preferably consists essentially of):

0.001-5% wt. of a nonionic surfactant based on ethoxy/propoxy block copolymers having a molecular weight of at least about 2500;
0.001-2% wt. of an amphoteric hydrotrope;

0.001-3% wt. of at least one anionic surfactant, preferably of the sulfonate type in conjunction with at least one nonionic surfactant constituent, preferably an alcohol alkoxylate;

optionally but desirably a preservative constituent;

optionally but desirably a defoaming constituent;

optionally but desirably a pH adjusting agent;

optionally one or more conventional additives; and,

at least 92% wt, preferably at least 94% wt. water, characterized in that the compositions exclude traditional organic solvents.

The inventive compositions described herein are provided as either ready to use products, or as dilutable products for application directly applied to a flooring surface, particularly to finished wooden flooring surface such as natural woods which are provided with a surface coating such as a polyurethane coating, varnish, shellac or other surface finish. When used as a ready to use product, the inventive compositions are used without further dilution and may be applied directly to a flooring surface without further dilution. When used as a dilatable product the inventive compositions are first mixed into an equivalent or larger volume of water so to provide a working composition therefrom. When diluted the inventive composition may be diluted in volume ratios of inventive composition:water of from 1:1-100, more preferably from 1:2-48 parts, yet more preferably from 1:4-36, and especially preferably in respective volume ratios of inventive composition:water of 1:16.

The floor cleaning compositions are used in a conventional manner, e.g., are sprayed or sprinkled onto a floor needing cleaning, such as from a conventional spray bottle, conventional squeeze bottle, or the like, and distributed by the use of a sponge or mop in a manual cleaning operation, or in a mechanical cleaning operation by the use of a motorized floor cleaning apparatus having a sponge. The sponge or mop may be predampened with water, or may be dry but is desirably predampened with the excess water squeezed out. Such dampening ensures that the flooring cleaning composition is not unduly absorbed and entrained in the interior of the mop or sponge. After application, the mop or sponge may be rinsed, as in a bucket of water, and applied floor cleaning composition wiped from the cleaned flooring surface. Afterwards, the compositions are optionally but desirably wiped, scrubbed or otherwise physically contacted with the hard surface, and further optionally, may be subsequently rinsed from such a cleaned hard surface.

The compositions of the invention may also be used as a general purpose cleaner for other hard surfaces, including finished wood surfaces, such as furniture, moldings, trim and the like.

Particularly preferred embodiments of the inventive compositions exhibit good long term storage stability, as evidenced by accelerated ageing testing of samples of the composition which, when maintained at 120° F. for 4 weeks remains substantially transparent, and does not suffer phase separation or precipitation of any constituents.

The following examples below illustrate exemplary formulations as well as preferred embodiments of the invention. It is to be understood that these examples are provided by way of illustration only and that further useful formulations falling within the scope of the present invention and the claims may be readily produced by one skilled in the art without deviating from the scope and spirit of the invention.

The following examples illustrate an exemplary formulation of the invention and particular preferred embodiments of the inventive compositions. The terms “parts by weight” or “percentage weight” as well as “% wt.” are used interchangeably in the specification and in the following Examples wherein the weight percentages of each of the individual constituents are indicated in weight percent based on the total weight of the composition, unless indicated otherwise.

### EXAMPLES

Preparation of Example Formulations:

Exemplary formulations illustrating certain preferred embodiments of the inventive compositions and described in more detail in Table 1 below were formulated generally in accordance with the following protocol. These constituents were used “as is” from their respective supplier.

Into a suitably sized vessel, a measured amount of water was provided after which the constituents were added in no specific or uniform sequence, which indicated that the order of addition of the constituents was not critical. All of the constituents were supplied at room temperature, and any remaining amount of water was added thereafter. Mixing of the constituents was achieved by the use of a mechanical stirrer with a small diameter propeller at the end of its rotating shaft. Mixing, which generally lasted from 5 minutes to 120 minutes was maintained until the particular exemplary formulation appeared to be homogeneous. The exemplary compositions were readily pourable, and retained well mixed characteristics (i.e., stable mixtures) upon standing for extend periods. The compositions of the example formulations are listed on Table 1.

TABLE 1

| | E1 | E2 | E3 | E4 | E5 | E6 |
|---|---|---|---|---|---|---|
| Pluronic L64 | 3.0 | 3.0 | 3.0 | 3.0 | 3.0 | 3.0 |
| Alfonic 810-4.5 | — | 0.5 | 0.5 | — | 0.5 | — |
| Amohoterge K-2 (40%) | 3.0 | 3.0 | 3.0 | 3.0 | 3.0 | 3.0 |
| Dowfax 2A1 (45%) | 1.0 | 1.0 | 1.0 | — | — | 1.0 |
| Silicone SE21 (10%) | 0.01 | 0.01 | 0.01 | 0.01 | 0.01 | 0.01 |
| Tetrasodium EDTA (38%) | 0.4 | 0.4 | 0.4 | 0.4 | 0.4 | 0.4 |
| Anhydrous citric acid (100%) | 0.2 | 0.2 | 0.2 | 0.2 | 0.2 | 0.2 |
| Kathon CG/ICP | 0.15 | 0.15 | 0.15 | 0.15 | 0.5 | 0.5 |
| Dyestuff | 0.01 | 0.01 | 0.012 | 0.01 | 0.01 | 0.01 |
| Fragrance | 0.3 | 0.3 | 0.3 | 0.25 | 0.25 | 0.25 |
| DI water | q.s. | q.s. | q.s. | q.s. | q.s. | q.s. |
| | E7 | E8 | E9 | E10 | E11 | E12 |
| Pluronic L64 | 3.0 | 3.0 | 1.5 | 3.0 | 3.0 | 3.0 |
| Alfonic 810-4.5 | 0.5 | — | 0.3 | — | — | — |
| Amphoterge K-2 (40%) | 3.0 | 4.0 | 3.0 | 3.0 | 6.0 | 6.0 |
| Dowfax 2A1 (45%) | 1.0 | — | — | — | 0.4 | — |
| Silicone SE21 (10%) | 0.01 | — | — | 0.05 | — | — |
| Tetrasodium EDTA (38%) | 0.4 | 0.4 | 0.4 | 0.4 | — | — |
| Anhydrous citric acid (100%) | 0.2 | 0.2 | 0.2 | 0.2 | 0.2 | 0.2 |
| Kathon CG/ICP | 0.5 | 0.5 | 0.5 | 0.5 | 0.4 | 0.4 |
| Dyestuff | 0.05 | 0.03 | 0.03 | 0.03 | 0.1 | 0.1 |
| Fragrance | 0.25 | 0.25 | 0.25 | 0.25 | 0.2 | 0.2 |
| DI water | q.s. | q.s. | q.s. | q.s. | q.s. | q.s. |

| | E13 | E14 |
|---|---|---|
| Pluronic L64 | 3.0 | 2.0 |
| Alfonic 810-4.5 | — | — |
| Amphoterge K-2 (40%) | 6.0 | 4.0 |
| PolyTergent CS-1 (50%) | 0.4 | 0.4 |
| Dowfax 2A1 (45%) | — | — |
| Silicone SE21 (10%) | — | — |
| Tetrasodium EDTA (38%) | — | — |
| Anhydrous citric acid (100%) | — | — |
| Kathon CG/ICP | 0.4 | 0.4 |
| Dyestuff | 0.1 | 0.1 |
| Fragrance | 0.2 | 0.2 |
| DI water | q.s. | q.s. |

As is indicated, to all of the formulations of Table 1 was added sufficient deionized water in “quantum sufficient” to provide 100 parts by weight of a particular formulation.

The identity of the constituents of Table 1 above are described in more detail on Table 2, below, including the “actives” percentage of each were a constituent was not provided by its supplier as 100% wt. “actives”.

TABLE 2

| | Function; Identity (supplier) |
|---|---|
| Pluronic L64 | ethylene oxide/propylene oxide block copolymer, |
| | avg. molecular weight 2900, 100% wt. actives, ex. |
| | BASF |
| Alfonic 810-4.5 | C₈-C₁₀ linear primary alcohol ethoxylates, avg. 4.5 |
| | mols ethoxylation, 100% wt. actives, ex. Condea |
| Amphoterge K-2 | disodium cocoamphodipropionate |
| (40%) | |
| PolyTergent CS-1 | anionic polycarboxylated alcohol alkoxylate, |
| (50%) | 50% wt. actives, ex. BASF |
| Dowfax 2A1 (45%) | Sodium dodecylbenzene sulfonate, 45% wt. |
| | actives, ex DOW |
| Silicone SE21 | defoaming constituent, 10% wt. actives, ex. |
| (10%) | |
| Tetrasodium EDTA | chelating agent; tetrasodium ethylene diamine |
| (38%) | tetraacetic acid, 38% wt. aqueous preparation |
| Anhydrous citric | pH adjusting agent; citric acid (anhydrous) |
| acid (100%) | |
| Kathon CG/ICP | proprietary composition |
| Dyestuff | proprietary composition |
| Fragrance | fragrance; proprietary composition |
| DI water | deionized water |

Cleaning Efficacy

The cleaning efficacy of a composition according to the invention was evaluated in the cleaning of samples of polyurethane finished oak flooring according to the protocol of the ASTM D4488 A2 Test Method. A standardized test soil comprising greasy soil sample containing vegetable oil, food shortening and animal fat was prepared and applied to the sample.

According to the test a sponge of a Gardner Abrasion Tester apparatus was squirted with an aliquot of a cleaning composition formed by diluting 1 part of the formulation according to Ex. 2 (E2) with 16 parts of water, and thereafter the apparatus was cycled 10 times. A similarly prepared sponge was then used with a comparative example composition as a comparative control, namely deionized water. The cleaning efficacy of the tested compositions was evaluated utilizing a Minolta Chroma Meter CF-110, with Data Processor DP-100, which evaluated spectrophotomic characteristics of the sample. This test was repeated six times in order to provide a statistically significant set of test replicates, and the results statistically analyzed to a 95% confidence level.

The reflectance values were then employed to calculate % soil removal according to the following formula:

$$\% soil removal = \frac{Rc - Rs}{Ro - Rs} \times 100 \%$$

wherein:
Rc=% reflectance average after scrubbing soiled tile;
Rs=% reflectance average before cleaning soiled tile;
Ro=% reflectance average original tile before soiling.

The results of the test are indicated on the following Table 3:

TABLE 3

| Tile/ | | | | |
|---|---|---|---|---|
| composition | Ro | Rs | Rc | % soil removal |
| 1/E2 | 47.82 | 41.41 | 48.96 | 117.78 |
| 2/E2 | 48.52 | 40.82 | 49.79 | 116.49 |
| 3/E2 | 50.93 | 40.57 | 51.78 | 108.20 |
| 4/E2 | 51.63 | 43.08 | 52.91 | 114.97 |
| 5/E2 | 54.85 | 43.36 | 57.41 | 122.28 |
| 6/E2 | 56.24 | 45.88 | 58.70 | 123.75 |
| | | | % soil removal, | 117.25 |
| | | | averaged = | |
| 1/water | 46.59 | 42.28 | 42.67 | 9.05 |
| 2/water | 47.53 | 40.03 | 41.20 | 15.60 |
| 3/water | 48.36 | 40.99 | 41.31 | 4.34 |
| 4/water | 49.76 | 40.82 | 41.44 | 6.94 |
| 5/water | 52.27 | 43.05 | 44.61 | 16.92 |
| 6/water | 53.42 | 43.39 | 44.67 | 12.76 |
| | | | % soil removal, | 10.93 |
| | | | averaged = | |

As the results of Table 3 indicate the cleaning efficacy evaluated was markedly superior to that of the plain water used as the comparative control cleaning composition.

Particularly striking was the apparent soil removal which was attained by the E2 compositions; the reported values for the “% soil removal” indicate that in addition to excellent cleaning the inventive compositions also significantly improved the luster and shine of the treated polyurethane finished oak flooring. Thus preferred embodiments of the inventive compositions provide the simultaneous benefits of excellent cleaning as well as excellent polishing of treated surfaces, particularly treated flooring surfaces.

While the invention is susceptible of various modifications and alternative forms, it is to be understood that specific embodiments thereof have been shown by way of example in the drawings which are not intended to limit the invention to the particular forms disclosed; on the contrary the intention is to cover all modifications, equivalents and alternatives falling within the scope and spirit of the invention as expressed in the appended claims.

1. Hard surface cleaning composition particularly adapted for the cleaning treatment of flooring surfaces, which composition comprises:
a nonionic surfactant based on ethoxy/propoxy block copolymers having a molecular weight of at least about 2200;
an amphoteric hydrotrope;
optionally but particularly desirably, one or more further detersive surfactants, preferably one or more anionic surfactants but preferably at least one anionic surfactant is present in conjunction with the nonionic surfactant constituent;
optionally one or more conventional additives; and,
water.

2. A hard surface cleaning composition according to claim 1 wherein;
the nonionic surfactant based on ethoxy/propoxy block copolymers has a molecular weight of at least about 2500.

3. A hard surface cleaning composition according to claim 1 wherein;
the amphoteric hydrotrope is selected from alkylampho(mono)propionates and alkylampho(di)propionates.

4. A hard surface cleaning composition according to claim 3 wherein;
the amphoteric hydrotrope is an alkylampho(di)propionate.

5. A hard surface cleaning composition according to any preceding claim wherein the composition is essentially free of organic solvents.

6. A hard surface cleaning composition according to any preceding claim which further comprises:
a further detersive surfactant selected from: anionic surfactants, nonionic surfactants, mixtures of an anionic and a nonionic surfactant.

7. A hard surface cleaning composition according to claim 6 wherein;
the composition comprises a nonionic alcohol ethoxylate surfactant.

8. A hard surface cleaning composition according to claim 6 wherein;
the composition comprises an anionic sulfonate surfactant.

9. A hard surface cleaning composition according to any preceding claim wherein;
the composition comprises at least 92% wt. water.

10. A hard surface cleaning composition according to claim 9 wherein;
the composition comprises at least 94% wt. water.

11. A hard surface cleaning composition at a pH of not more than 7 adapted for the cleaning treatment of flooring surfaces, which composition comprises (but preferably consists of, more preferably consists essentially of):
0.001-5% wt. of a nonionic surfactant based on ethoxy/propoxy block copolymers having a molecular weight of at least about 2500;
0.001-2% wt. of an amphoteric hydrotrope;
0.001-3% wt. of at least one anionic surfactant, preferably of the sulfonate type in conjunction with at least one nonionic surfactant constituent, preferably an alcohol alkoxylate;
optionally but desirably a preservative constituent;
optionally but desirably a defoaming constituent;
optionally but desirably a pH adjusting agent;
optionally one or more conventional additives; and,
at least 92% wt, preferably at least 94% wt. water,
characterized in that the compositions exclude traditional organic solvents.

12. A hard surface cleaning composition substantially described with reference to the Examples.

13. A process for the cleaning of a hard surface, preferably flooring surfaces such as finished wood flooring, finished wood veneer flooring and finished non-wood flooring surfaces which are intended to provide the appearance of wood flooring surfaces, which process includes the step of providing a cleaning effective amount of the hard surface cleaning composition according to any preceding claim to the hard surface.
